(19) United States
(12) Patent Application Publication
(10) Pub. No.: US 2011/0198901 A1
(43) Pub. Date: Aug. 18, 2011

(54) Roller Blind Arrangement

(75) Inventor: Stefan Kaiser, Dinkelscherben (DE)

(73) Assignee: HS Genion GmbH, Gilching (DE)

(21) Appl. No.: 13/018,164

(22) Filed: Jan. 31, 2011

(30) Foreign Application Priority Data
Feb. 12, 2010 (DE) 10 2010 007 732.1

(51) Int. Cl. B60N 2/44; E06B 9/42; E06B 9/60; A47C 7/62

(52) U.S. Cl. 297/217.1; 160/127

(57) ABSTRACT

The invention relates to a roller blind arrangement for a motor vehicle, comprising a roller blind web which can be wound up by a winding device to form a wound body and which has a pulling device at its free end facing away from the wound body. Winding up and/or extending the roller blind web triggers actuation of a cleaning brush that removes any soiling from the roller blind web.

### BACKGROUND OF THE INVENTION

1. Field of the Invention

The invention relates to a roller blind arrangement for a motor vehicle, comprising a roller blind web which can be wound up by means of a winding device to form a wound body and which has a pulling device at its free end facing away from the wound body, and to a vehicle seat comprising a seat element and a backrest that may have an extendable protective cover at least for the seat element.

2. Related Technology

Roller blind arrangements are used in various ways in the field of motor vehicles. By way of example, a roller blind can be used to shade a transparent roof section or else to shade side windows of the motor vehicle. Furthermore, roller blind arrangements are used as a top-side loading space cover which is equipped with a roller blind cassette, which is fixed at the rear to a backrest of a vehicle rear bench. Mounted rotatably in the roller blind cassette is a winding shaft, to which there is fixed a roller blind web that can be wound up onto the winding shaft or unwound from the winding shaft. The unwinding process is generally performed manually. The winding-up process can be performed by means of a winding spring, which pre-stresses the winding shaft in the winding-up direction so that the roller blind web is wound up automatically once it has been released.

A disadvantage with known roller blind arrangements is that in particular the top side of the roller blind web becomes dirty over time. When the roller blind web is wound up, this leads to the dirt being transferred from the top side of the roller to the underside of the roller. Cleaning the roller blind web is therefore complicated and may not even be possible at all in an adequate manner.

Furthermore, it is known from practice to provide vehicle seats with a protective cover to protect the permanent upholstery cover. Such a protective cover is generally stretched over the upholstery, as a result of which the permanent upholstery cover is covered at least at locations prone to becoming dirty. Fixing and removing such protective covers is in each case time-consuming.

The invention provides a roller blind arrangement having an effective cleaning function and also an easily installable protective cover.

According to the invention, a roller blind for a motor vehicle comprises a roller blind web that can be wound up by a winding device to form a wound body and which has a pulling device at a free end facing away from the wound body, wherein winding up and/or extending the roller blind web triggers actuation of a cleaning brush that removes any soiling from the roller blind web.

The invention provides a roller blind web having an integrated cleaning function in the form of a brush that is always and automatically actuated together with the winding process of the roller blind web. The roller blind web is thus subject to continuous cleaning while it is wound up and/or unwound.

In a preferred embodiment of the roller blind arrangement according to the invention, the cleaning brush is a rotating brush, the axis of which is oriented at least approximately parallel to the axis of the wound body and which rotates when the roller blind web is actuated. The rotating brush is thus driven by the rotary movement of the winding body or roller blind body.

The winding device, by means of which the roller blind web can be wound up to form a wound body, is preferably a winding shaft that is pre-stressed in the winding-up direction by a winding spring.

To couple the winding shaft and the cleaning brush, it is preferred that the winding shaft be connected to the cleaning brush via gearing.

The gearing can have various forms. These forms for example depend on the desired direction of rotation of the cleaning brush, which is generally in the form of a rotating brush. If the direction of rotation of the rotating brush is intended to correspond to the direction of rotation of the winding shaft, the gearing may comprise for example a toothed belt or a V-belt, which is arranged on corresponding belt pulleys of the winding shaft and of the cleaning brush. In the case of a toothed belt, the belt pulleys can be spur gears or gearwheels.

If the respective directions of rotation of the winding shaft and of the rotating brush are intended to be opposite from each other, the gearing preferably comprises spur gears on the winding shaft and on the cleaning brush, with the spur gears meshing with one another.

To counteract dirt on the cleaning brush, it is preferredwhen the cleaning brush runs over a dirt stripper when it is actuated, said dirt stripper being for example in the form of a strip.

To be able to dispose in a targeted manner of the dirt that the dirt stripper removes from the cleaning brush and to be able to keep the roller blind arrangement as a whole clean, the dirt stripper preferably delivers the dirt stripped off by the cleaning brush into a dirt trap, which is preferably in the form of a dirt drawer.

Expediently, the roller blind arrangement according to the invention is equipped with a roller blind cassette, in which the winding shaft and the cleaning brush are mounted. When it is present, the roller blind cassette also accommodates the dirt stripper and the dirt trap or dirt drawer, which can then be removed and emptied independently of the other mechanisms of the roller blind arrangement.

The roller blind arrangement according to the invention can have various applications within a vehicle. In particular, however, the roller blind arrangement is designed in such a way that the roller blind web is an extendable loading space cover or an extendable protective cover for a vehicle seat.

The invention also provides a vehicle seat, which comprises a seat element and a backrest. This vehicle seat comprises according to the invention at least one extendable protective cover at least for the seat element.

The extendable protective cover preferably is formed by a roller blind web of a roller blind arrangement.

In a preferred embodiment of the vehicle seat according to the invention, the extendable protective cover formed by a roller blind web of a roller blind arrangement is equipped with a cleaning brush of the kind described above.

Preferably, the roller blind web has a hook-in device, by which it can be secured in its extended position, in which the seat element is covered.

The arrangement of the roller blind arrangement of the vehicle seat preferably is chosen such that the roller blind web engages through a gap between the backrest and the seat element. A user can thus grip an extension tab or an extension bow of the roller blind web in the wound-up state thereof and pull the roller blind web over the seat element. In this way, the seat element can be protected from undesired soiling, for example when children are being carried along.

The protective cover formed within the meaning of the invention preferably forms a support surface for a child seat, as a result of which the child seat can be prevented from leaving impressions in the permanently arranged seat cover or upholstery cover.

By way of example, the vehicle seat according to the invention, which is equipped with the extendable protective cover, can additionally be equipped with fixing brackets for a child seat.

Further advantages and advantageous configurations of the subject matter of the invention can be gathered from the description, the drawing and the patent claims.

### BRIEF DESCRIPTION OF THE DRAWINGS

An exemplary embodiment of a motor vehicle having roller blind arrangements according to the invention is illustrated in a schematically simplified manner in the drawing and explained in more detail in the subsequent description. In the drawing:

FIG. 1 shows a schematic side view of a motor vehicle having roller blind arrangements according to the invention; and

FIG. 2 shows a schematic and perspective plan view of a roller blind arrangement individually.

### DETAILED DESCRIPTION

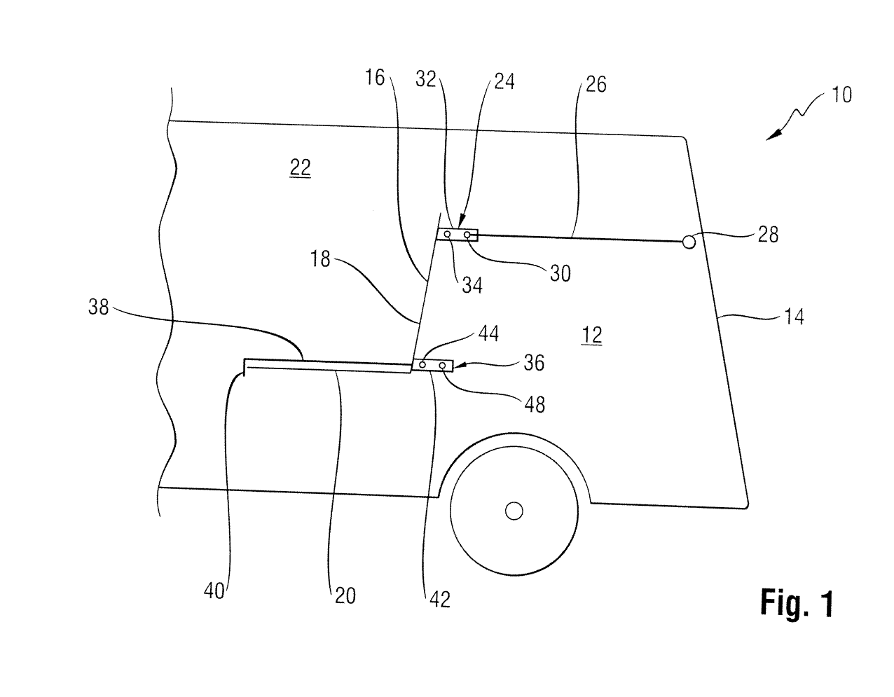

FIG. 1 illustrates a motor vehicle 10, which is in the form of what is known as a station wagon and has a storage space 12 which is bounded to the rear by a tailgate 14. To the front, the storage space 12 is bounded by a backrest 16 of a rear seat 18 of the motor vehicle 10, said rear seat 18 having, in addition to the backrest 16, a seat element 20, which forms the seating surface for a vehicle occupant.

In order to be able to close off the storage space 12 on the top side and to be able to protect a vehicle passenger compartment 22 from objects that could be flung out of the storage space 12 into the vehicle passenger compartment 22 in the event of an accident or the like, the motor vehicle 10 further has a storage space cover 24 in the form of a roller blind arrangement and comprising an extendable roller blind web 26. The roller blind web 26 has at its free, rear end a pulling bow 28, via which the roller blind web 26 can be secured in the extended state to a hook-in element (not shown) of the vehicle body. The roller blind web 26 is fastened by an end facing away from the pulling bow 28 to a winding shaft 30, which is rotatably mounted in a roller blind cassette 32 and which is pre-stressed in the winding-up direction of the roller blind web 26 by a winding spring (not illustrated in more detail here). Thus, when the pulling bow 28 is released, the roller blind web 26 is automatically wound up onto the winding shaft 30.

The roller blind arrangement 24 additionally has a cleaning brush 34, which is in the form of a rotating brush and is coupled to the winding shaft 30 via a gearing (not illustrated in more detail) and, when the winding shaft 30 is rotated, removes the dirt that may have been deposited on the top side of the roller blind web 26. The direction of rotation of the rotating brush 34 is the same as the direction of rotation of the winding shaft 30. In this case, the gearing preferably comprises a toothed belt that is arranged on gearwheels on the winding shaft 30 and on the rotating brush 34. The rotating brush 34 is thus driven by the force of the winding spring of the winding shaft 30 when the roller blind web 26 is wound up.

Arranged in the region of a transition between the backrest 16 and the seat element 20 of the rear seat 18 of the motor vehicle 10 is a further roller blind arrangement 36, which comprises a roller blind web 38 which serves as an extendable protective cover for the seat element 20 of the rear seat 18. To fix it in its extended position covering the seat element 20, the roller blind web 38 has at its free end a hook-in device 40, in the form for example of a hook or the like, which can be brought into engagement with a corresponding counter-element secured to the seat.

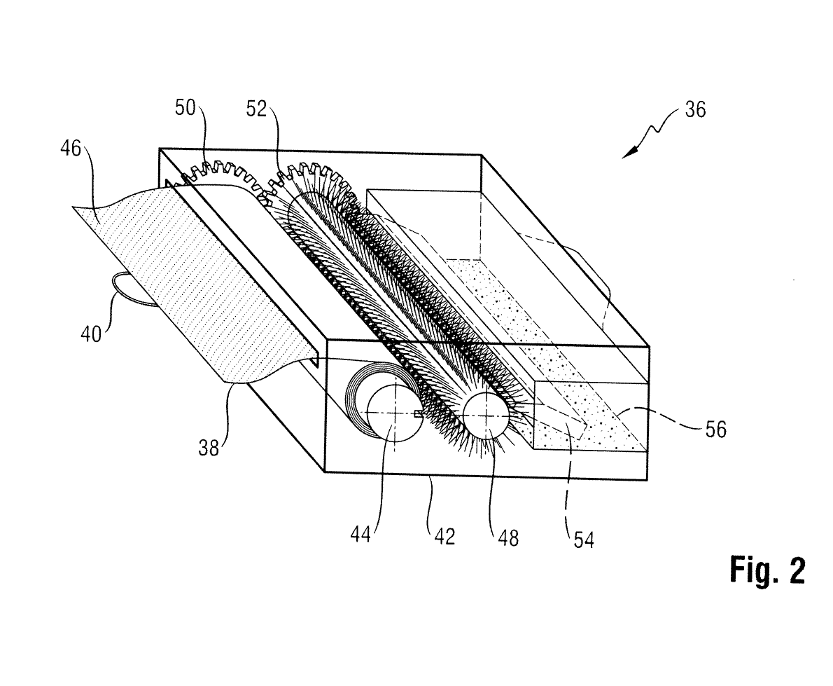

The roller blind arrangement 36, the basic structure of which corresponds to that of the roller blind arrangement 24, is illustrated in detail in FIG. 2. It comprises a roller blind cassette 42, which forms a housing, is fitted in a manner secured to the seat and rotatably mounted in which is a winding shaft 44, which is fixed in the roller blind web 38 by its end facing away from the hook-in device 40 and onto which the roller blind web 38 can be wound. The winding shaft 44 is pre-stressed in the winding-up direction of the roller blind web 38 by a winding spring, so that said roller blind web 38 can be wound up automatically. Furthermore, the hook-in device 40 of the roller blind web 38 adjoins a pulling bow 46 of the roller blind web 38, said pulling bow 46 representing a rigid thickening of the roller blind web and preventing the roller blind web 38 from plunging completely into the roller blind cassette 42 or being completely accommodated thereby when it is wound up.

To clean the top side of the roller blind web 38, which engages through a gap between the backrest 16 and the seat element 20, there is arranged in the roller blind cassette 42 a rotating brush 48, the axis of rotation of which is oriented parallel to the axis of rotation of the winding shaft 44 and which is coupled in terms of rotation to the winding shaft 44 via a spur gear 52, which is arranged at one end of the rotating brush 48 and meshes with a spur gear 50 on the winding shaft 44. A rotation of the winding shaft 44 consequently leads to a rotation in the opposite direction of the rotating brush 48, as a result of which the top side of the roller blind web 38 is cleaned.

A dirt stripper 54 is furthermore arranged in the roller blind cassette 42, said dirt stripper 54 being formed of a strip that is oriented parallel to the axis of the rotating brush 48 and strips dirt from the bristles of the rotating brush 48 when the rotating brush is rotated. This dirt is delivered into a dirt trap 56 in the form of a drawer, which for emptying purposes can be removed from the roller blind cassette 42 and emptied, independently of the other mechanisms of the roller blind arrangement 36.

List of reference numerals
10 Motor vehicle
12 Storage space
14 Tailgate
16 Backrest
18 Back seat
20 Seat element
22 Vehicle passenger compartment
24 Storage space cover
26 Roller blind web
28 Pulling bow
30 Winding shaft
32 Roller blind cassette
34 Cleaning brush
36 Roller blind arrangement
38 Roller blind web
40 Hook-in device
42 Roller blind cassette
44 Winding shaft
46 Pulling bow
48 Rotating brush
50 Spur gear
52 Spur gear
54 Dirt stripper
56 Dirt trap

1. A roller blind arrangement for a motor vehicle, comprising a roller blind web that can be wound up by a winding device to form a wound body and that has a pulling device at a free end facing away from the wound body, wherein winding up and/or extending the roller blind triggers actuation of a cleaning brush that removes any soiling from the roller blind web.

2. The roller blind arrangement as claimed in claim 1, wherein the cleaning brush is a rotating brush, an axis of which is at least approximately parallel to an axis of the wound body and which rotates when the roller blind web is actuated.

3. The roller blind arrangement as claimed in claim 1, wherein the winding device is a winding shaft that is pre-stressed in a winding-up direction by a winding spring.

4. The roller blind arrangement as claimed in claim 2, wherein the winding shaft is connected to the cleaning brush via gearing.

5. The roller blind arrangement as claimed in claim 4, wherein the gearing comprises a toothed belt or a V-belt, which is arranged on pinions or belt pulleys of the winding shaft and of the cleaning brush.

6. The roller blind arrangement as claimed in claim 4, wherein the gearing comprises spur gears, which are arranged on the winding shaft and on the cleaning brush and which mesh with one another.

7. The roller blind arrangement as claimed in claim 1, wherein the cleaning brush runs over a dirt stripper when it is actuated.

8. The roller blind arrangement as claimed in claim 7, wherein the dirt stripper delivers the dirt stripped off by the cleaning brush into a dirt trap.

9. The roller blind arrangement as claimed in claim 1, comprising a roller blind cassette, in which the winding shaft and the cleaning brush are mounted.

10. The roller blind arrangement as claimed in claim 1, wherein the roller blind web is an extendable loading space cover or an extendable protective cover for a vehicle seat.

11. A vehicle seat, comprising a seat element and a backrest, said vehicle seat having an extendable protective cover at least for the seat element.

12. The vehicle seat as claimed in claim 11, wherein the extendable protective cover is formed by a roller blind web of a roller blind arrangement.

13. The vehicle seat as claimed in claim 11, wherein the extendable protective cover is formed by a roller blind web of a roller blind arrangement comprising a roller blind web that can be wound up by a winding device to form a wound body and that has a pulling device at a free end facing away from the wound body, wherein winding up and/or extending the roller blind triggers actuation of a cleaning brush that removes any soiling from the roller blind web.

14. The vehicle seat as claimed in claim 12, wherein the roller blind web has a hook-in device, by which the roller blind web can be secured in an extended position covering the seat element.

15. The vehicle seat as claimed in claim 12, wherein the roller blind web engages through a gap between the backrest and the seat element.

16. The vehicle seat as claimed in claim 11, wherein a roller blind cassette is arranged in the region of the transition between the seat element and the backrest.

17. The roller blind arrangement as claimed in claim 8, wherein the dirt trap is a dirt drawer.

18. The vehicle seat as claimed in claim 13, wherein the roller blind web has a hook-in device, by which the roller blind web can be secured in an extended position covering the seat element.

19. The vehicle seat as claimed in claim 13, wherein the roller blind web engages through a gap between the backrest and the seat element.

20. The vehicle seat as claimed in claim 13, wherein a roller blind cassette is arranged in the region of the transition between the seat element and the backrest.
